(19) United States
(12) Patent Application Publication
(10) Pub. No.: US 2013/0166688 A1
(43) Pub. Date: Jun. 27, 2013

(54) COMMUNICATION SYSTEM, NETWORK STORAGE, SERVER

(71) Applicant: BUFFALO INC., Nagoya-shi (JP)

(72) Inventor: Yukihito HARA, Nogoya-shi (JP)

(73) Assignee: BUFFALO INC., Nagoya-shi (JP)

(21) Appl. No.: 13/716,788

(22) Filed: Dec. 17, 2012

(30) Foreign Application Priority Data
Dec. 26, 2011 (JP) 2011-284129

(51) Int. Cl. H04L 12/46

(52) U.S. Cl. CPC H04L 12/46; H04L 63/083
USPC 709/218; 726/5

(57) ABSTRACT

A communication system including a server connected to a first network, a network storage connected to a second network different from the first network and communicates with the server, and a user terminal. The network storage transmits a storage request signal to the server, the server transitions to a standby state in response to the storage request signal and issues setup information including storage identification information identifying the network storage. The network storage receives and outputs the setup information, and the user terminal transmits a user request signal including the storage identification information and terminal identification information based on the setup information. The server then associates the terminal identification information and the storage identification information upon receiving the user request signal.

### CROSS-REFERENCE TO RELATED APPLICATION

This non-provisional application claims priority under 35 U.S.C. §119(a) to Patent Application No. 2011-284129 filed in Japan on Dec. 26, 2011, the entire contents of which are hereby incorporated by reference.

### BACKGROUND

The present disclosure relates to a communication system that performs pairing between a user terminal and a network storage, a network storage, and a server device.

In recent years, the network storage (network attached storage (NAS)) having a high-capacity external storage device is utilized in homes and offices. Such a network storage is connected to a LAN (Local Area Network) in the home or office.

Meanwhile, regarding portable user terminals such as smartphones, which are becoming popular recently, there is a need to utilize the network storage in order to compensate for the storage capacity of the user terminal and store the backup. The portable user terminal such as the smartphone is frequently used not only in homes and offices but also at outside locations because of the nature of the device. At outside locations, the user terminal is connected to a wide area network such as the Internet via a cell-phone line or the like.

So, it is required to enable access from such a user terminal to a network storage connected to a LAN in the home or office via a wide area network. In general, a gateway (router) is set between a wide area network and a LAN and this router performs translation from an IP address used in the connection to the wide area network to an IP address used on the LAN side (network address translation (NAT)). Therefore, it is impossible for the user terminal connecting to the wide area network to directly specify the IP address of a device (here, network storage) connected to the LAN and access the device connected to the LAN. This is because the address in the LAN is not the address on the wide area network side. To address this, as techniques enabling access from the above-described user terminal to a network storage have been proposed.

In on example, direct access between a user terminal and a network storage is enabled by utilizing the UPnP (Universal Plug and Play) function of a router to which the network storage is connected. In another example, a relay server provided on a wide area network performs associating (pairing) between a user terminal and a network storage to enable a relay of data between the user terminal and the network storage.

As a technique for the pairing between two devices, a technique in which terminal identification information to identify one device (e.g. user terminal) is registered in the other device (e.g. television) has also been proposed

In the technique including the relay server, setup of the router and so forth is simple because a relay server is utilized. However, in such a service, when pairing a user terminal with a network storage, the user needs to configure the settings by using a PC or the like connected to the same network as that of the network storage.

Therefore, for the user who does not have a PC connected to the same network as that of the network storage and the user who is unaccustomed to setup by use of a PC, the settings are difficult and thus it is difficult to utilize the network storage.

The present disclosure is made in order to solve the above-described problem and one of objects thereof is to provide a communication system, a network storage, and a server device that enable easy pairing between a user terminal and a network storage.

### SUMMARY

According to an exemplary embodiment, the present disclosure is directed to a network storage that communicates with a server device connected to a first network and is connected to a second network different from the first network. The network storage includes a communication interface that transmits, to the server, a storage request signal causing the server to transition to a standby state to wait for a user request signal transmitted from a user terminal capable of communicating with the server in response to predetermined operation. The communication interface of the network storage also receives setup information issued by the server in response to the storage request signal and includes storage identification information identifying the network storage. The network storage then outputs the setup information received from the server device.

### BRIEF DESCRIPTION OF THE DRAWINGS

FIG. 1 is a diagram showing a communication system according to an embodiment of the present disclosure;

FIG. 2 is a block diagram showing a network storage according to the embodiment of the present disclosure;

FIG. 3 is a diagram showing a light blinking pattern according to the embodiment of the present disclosure;

FIG. 4 is a block diagram showing a user terminal according to the embodiment of the present disclosure;

FIG. 5 is a block diagram showing a server device according to the embodiment of the present disclosure;

FIG. 6 is a sequence diagram showing the operation of the communication system according to the embodiment of the present disclosure;

FIG. 7 is a sequence diagram showing the operation of the communication system according to the embodiment of the present disclosure;

FIG. 8 is a diagram for explaining another mode of the embodiment of the present disclosure;

FIG. 9 is a diagram for explaining another mode of the embodiment of the present disclosure; and

FIG. 10 is a diagram showing a network storage according to further another mode of the embodiment of the present disclosure.

### DETAILED DESCRIPTION

In the following, a network storage and a server device according to an embodiment of the present disclosure will be described with reference to the drawings. In the following description of the drawings, the same or similar part is given the same or similar symbol.

It should be noted that the drawings are schematic and the ratio of the respective sizes is different from the actual ratio. Therefore, the specific sizes and so forth should be determined by taking the following description into consideration. Furthermore, it is obvious that part with difference in the mutual size relationship and ratio between the drawings is also included.

A communication system according to an embodiment of the present disclosure includes a server device that is connected to a first network and is capable of communicating with a user terminal and a network storage that is connected to a second network different from the first network and is so set as to be capable of communicating with the server device. This network storage transmits a storage request signal to the server device in response to predetermined operation to the network storage. The server device transitions to a standby state in response to the storage request signal. The network storage receives setup information from the server device and outputs the setup information. The user terminal transmits, to the server device, a user request signal including storage identification information to identify the network storage and terminal identification information to identify the user terminal by using the setup information output by the network storage. The server device associates the user terminal with the network storage if receiving the user request signal from the user terminal in the standby state. The setup information is information uniquely associated with the network storage.

In the embodiment of the present disclosure, the server device transitions to the standby state in response to the storage request signal transmitted from the network storage in response to the predetermined operation to the network storage, and associates the user terminal with the network storage if receiving the user request signal in the standby state.

In the embodiment of the present disclosure, the server device transmits the setup information uniquely associated with the network storage to the network storage in response to the storage request signal.

Therefore, writing or the like on which the setup information is printed does not need to be supplied with the network storage in order to convey the setup information uniquely associated with the network storage.

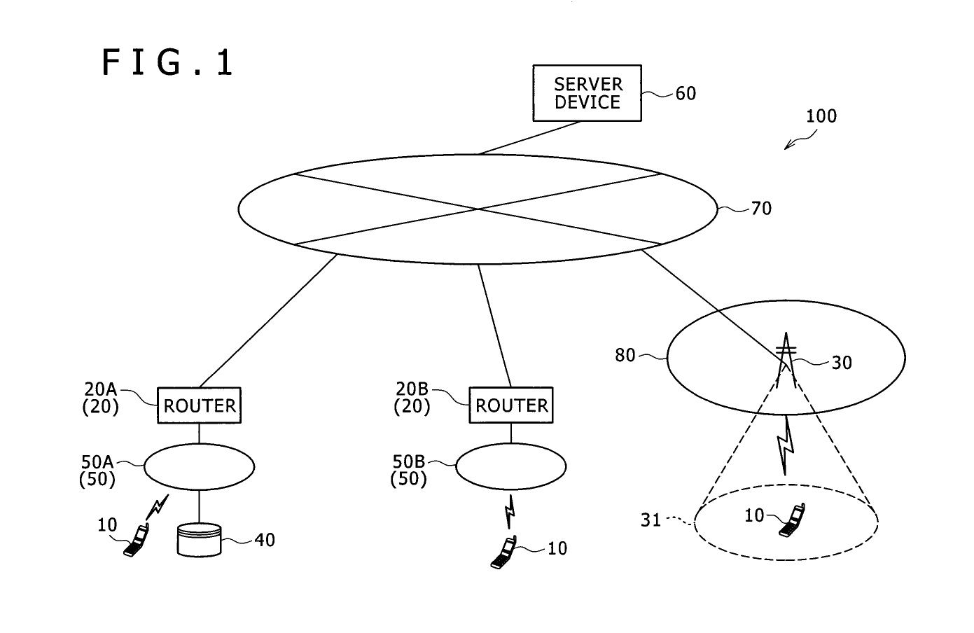

The communication system according to the embodiment of the present disclosure will be described below. FIG. 1 is a configuration block diagram showing a communication system 100 according to the embodiment of the present disclosure.

As shown in FIG. 1, the communication system 100 includes a user terminal 10, a router 20, a wireless base station 30, a network storage 40, a home network 50A, an external network 50B, a server device 60, a wide area network 70, and a mobile communication network 80.

The user terminal 10 is e.g. a cell phone such as a smartphone or a digital camera. The user terminal 10 establishes a wireless connection of a system such as 3G (third generation) or LTE (long term evolution) with the wireless base station 30 provided in the mobile communication network 80. This user terminal 10 may establish a wireless connection based on a wireless LAN standard with the router 20. Details of the user terminal 10 will be described later (with reference to FIG. 4).

The router 20 is connected to the LAN 50 and the wide area network 70 and performs network address translation (NAT) to translate an IP address used in the connection to the wide area network 70 (hereinafter, such an IP address will be referred to as the WAN-side IP address) to an IP address used in the connection to a device on the LAN side (hereinafter, such an IP address will be referred to as the local IP address). This router 20 may have a function of a wireless LAN access point. In this case, the router 20 forms a cover area, which is the range of the reach of radio waves output from the router 20, and wirelessly communicates with the user terminal 10 located in this cover area. In the following description, an example in which a router 20A and a router 20B are provided as the router 20 is shown.

In the embodiment of the present disclosure, the router 20A is connected to an in-house LAN in the user's home or the like (home network 50A) and the wide area network 70. The router 20B is connected to a LAN other than the in-house LAN (e.g. public wireless LAN) and the wide area network 70.

The wireless base station 30 is a base station set up by a mobile communications carrier and establishes a wireless connection of a system such as 3G or LTE, which is a standard of a mobile communication network, with the user terminal 10 located in a cover area 31 as the range of the reach of radio waves output from this wireless base station 30.

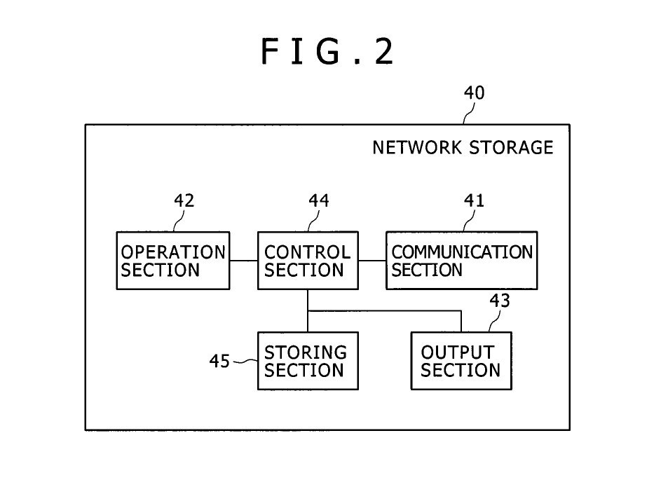

The network storage 40 has a data storing function and a communication function. In the embodiment of the present disclosure, the network storage 40 is connected to the home network 50A. For example, this network storage 40 is connected to a wired LAN port of the router 20A via a network cable. However, it is enough that the network storage 40 is connected to the router 20A by a network interface. Therefore, the network storage 40 may be connected to the router 20A not by a wired measure but wirelessly. Details of the network storage 40 will be described later (with reference to FIG. 2).

The home network 50A is one example of the in-house LAN. This home network 50A is one example of the second network. The external network 50B is one example of the LAN. The mobile communication network 80 is configured by a device provided by a mobile communications carrier similarly to the wireless base station 30.

The server device 60 can be connected via the wide area network 70. This server device 60 is connected to the first network and is so set as to be capable of communicating with the network storage 40 connected to the home network 50A. The server device 60 can also communicate with the user terminal 10.

The server device 60 may be capable of communicating with the user terminal 10 connected to the external network 50B or the mobile communication network 80 and may be capable of communicating with the user terminal 10 connected to the home network 50A. The access path on the wide area network 70 between the user terminal 10 and the server device 60 may be the same as the access path on the wide area network 70 between the network storage 40 and the server device 60.

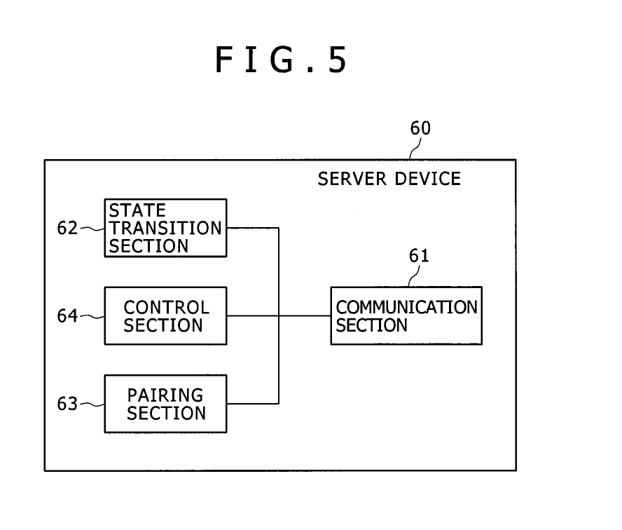

The server device 60 associates the user terminal 10 with the network storage 40. Details of the server device 60 will be described later (with reference to FIG. 5).

The wide area network 70 is e.g. the Internet. Various server devices are connected to the wide area network 70. In a certain example of the present embodiment, the server device 60 is connected to the first network, which is part of this wide area network 70. Communication by use of the so-called WAN-side IP address is carried out in the wide area network 70 (network including the first network) and communication utilizing the local IP address is carried out in the home network 50A (second network). Thus, the local IP address used in the home network 50A is assigned to the network storage 40 connected to the home network 50A. Therefore, it is impossible to carry out communication to this network storage 40 directly from the WAN side. For access to the network storage 40 existing in the home network 50A from the side of the wide area network 70, network address translation (NAT) to translate the WAN-side IP address of the router used in the connection to the wide area network 70 to the local IP address of the network storage 40 is necessary.

In the following, the network storage according to the embodiment of the present disclosure will be described below. FIG. 2 is a configuration block diagram showing an example of the network storage 40 according to the present embodiment.

As shown in FIG. 2, the network storage 40 includes a communication section 41, an operation section 42, an output section 43, a control section 44, and a storing section 45.

The communication section 41 is e.g. a wired LAN module. The communication section 41 is connected to the second network (home network 50A) and communicates with the server device 60 that is so set as to be capable of communication via the wide area network 70.

The operation section 42 includes a button and so forth. As described later, the control section 44 transmits the storage request signal when predetermined operation to this operation section 42 is performed. The storage request signal is a signal for causing the server device 60 to transition to the standby state to wait for the user request signal transmitted from the user terminal 10. The storage request signal includes at least the storage identification information to identify the network storage 40. The storage identification information is e.g. unique identification information assigned to the network storage 40 or a MAC (media access control) address set in the communication section 41 of the network storage 40.

The output section 43 is e.g. a display section, an LED (light emitting diode) lamp, or a speaker. This output section 43 carries out operation of outputting a signal based on the setup information received from the server device 60. Examples thereof will be described later.

The setup information includes at least information for access to the server device 60 (e.g. address (URL (uniform resource locator)) information of the server device 60) and the storage identification information to identify the network storage 40.

In one example of the present embodiment, this setup information includes URL information as reference information of a webpage provided by the server device 60 and the storage identification information. This URL information may be URL information obtained by coupling the storage identification information to identify the network storage 40 as a parameter to the URL of a webpage provided by the server device 60. The URL information uniquely associated with the network storage 40 in this manner will be referred to as individual URL information hereinafter, and URL information that does not include such a parameter will be referred to as general-purpose URL information. The storage identification information may include e.g. the MAC address of the network storage 40.

The output form of the output section 43 will be described below. In a certain example of the present embodiment, the output section 43 is a display and outputs the setup information as a computer-readable image, specifically e.g. a barcode, a QR code, or a character string that can be recognized by optical character recognition (OCR).

If the output section 43 is a lamp such as an LED, it outputs the setup information as a light blinking pattern. In general, the network storage 40 is equipped with an LED for informing the external of its state. Therefore, this LED (indicator lamp) may be used as the output section 43.

The output section 43 may be a speaker. In this case, it outputs the setup information as sounds.

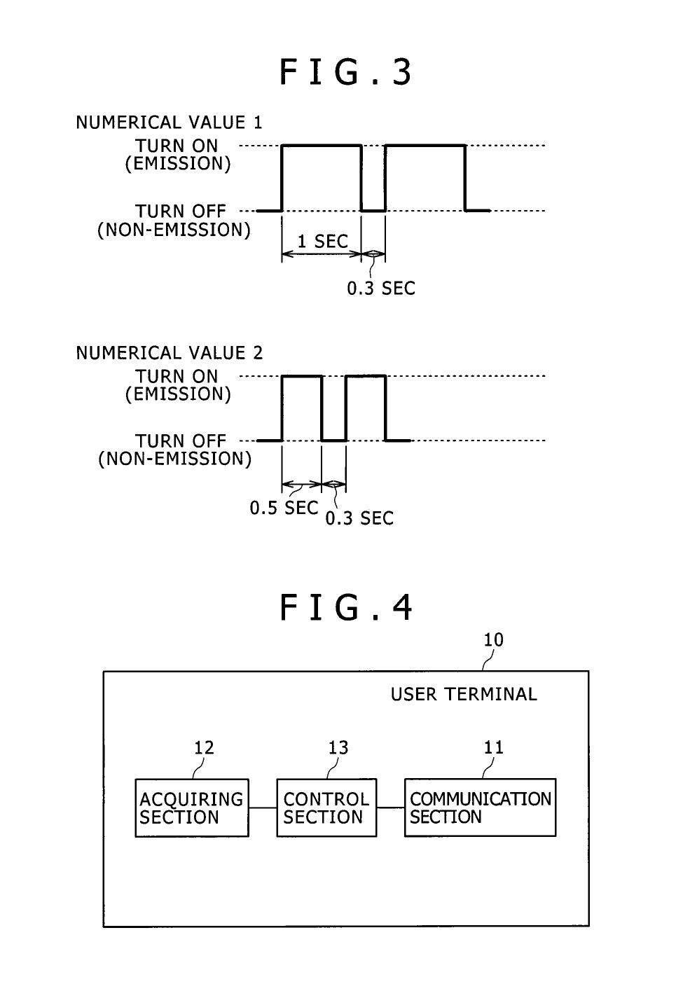

If the output section 43 outputs the setup information as a light blinking pattern as described above, the blinking pattern and codes are defined in association with each other in advance. Specifically, as exemplified in FIG. 3, one numerical value configuring the code is represented based on the combination of the length of the emission period and the length of the non-emission period (see “numerical value 1” and “numerical value 2” shown in FIG. 3). In this example, the setup information is represented as a string of numerical values as the code. For example, when the setup information is a numerical value string of “8866,” the blinking corresponding to “8” is repeated twice and then the blinking corresponding to “6” is repeated twice. The blinking pattern is not limited thereto. For example, simply each of the numerical values included in a numerical value string may be represented by the number of times of blinking.

If the output section 43 outputs the setup information as sounds, a method of representing information based on the combination of the sound pitch like the dual-tone multi frequency (DTMF) sound can be utilized. In this method, the setup information can be represented as a string of sounds with predetermined pitch represented by using the DTMF sound or the like. In this example, the setup information represented by e.g. a string of numerical values is represented by sequentially generating the pitch corresponding to the respective numerical values (sounds with the corresponding frequency). For example, in the case of converting a numerical value string of “8866” to sounds, the pitch associated with “8” (e.g. defined as output of a sound with 800 Hz for three seconds) is repeated twice and subsequently the pitch associated with “6” (e.g. defined as output of a sound with 600 Hz for three seconds) is repeated twice. Not pitch but sound length (sound output period) may be associated with numerical values and a numerical value string representing the setup information may be expressed as a string of sounds with the sound lengths corresponding to the respective numerical values. If there is no need to consider the order of the numerical values in the numerical value string, sounds with plural frequencies each corresponding to numerical value in the numerical value string may be collectively output.

The control section 44 is a program control device such as a CPU (central processing unit) and controls the network storage 40. For example, this control section 44 instructs the communication section 41 to transmit the storage request signal in response to predetermined operation carried out to the operation section 42. Furthermore, when receiving the setup information, the control section 44 instructs the output section 43 to output the setup information.

The communication section 41 that has received this instruction from the control section 44 transmits the storage request signal to the server device 60 via the second network (home network 50A).

The storing section 45 is a hard disk or the like. Alternatively, the storing section 45 may be a solid state drive (SSD) configured by a flash memory.

Next, the user terminal 10 will be described below. FIG. 4 is a configuration block diagram showing an example of the user terminal 10 according to the present embodiment.

As shown in FIG. 4, the user terminal 10 includes a communication section 11, an acquiring section 12, and a control section 13.

The communication section 11 includes an antenna, a wireless module, etc. This communication section 11 detects radio waves output from the wireless base station 30 and establishes a wireless connection with the wireless base station 30. This communication section 11 may have a function to detect radio waves output from the router 20 and establish a wireless connection with the router 20.

Specifically, this communication section 11 communicates with the server device 60 capable of communication via the wide area network 70. The communication section 11 is connected to the home network 50A, the external network 50B, or the mobile communication network 80 and communicates with the server device 60 via these networks or the mobile communication network and the wide area network 70.

The acquiring section 12 includes e.g. a camera or a microphone. This acquiring section 12 acquires the setup information output by the network storage 40.

For example if the network storage 40 outputs the setup information as a computer-readable image (barcode, QR code, or OCR-enabled character string), e.g. a camera can be used as the acquiring section 12. If the network storage 40 outputs the setup information as a blinking pattern by an LED or the like, a camera capable of photographing a moving image (capable of continuously acquiring images of a certain time) is suitable for this acquiring section 12.

If the network storage 40 outputs the setup information as sounds, a microphone can be used as this acquiring section 12.

For example if the acquiring section 12 acquires the setup information output as a light blinking pattern, e.g. the control section 13 detects the code corresponding to this light blinking pattern and generates a numerical value string defined in advance in association with the detected code. Thereby, the setup information is acquired.

If the acquiring section 12 acquires the setup information output as sounds, these sounds are converted to an electrical signal by the acquiring section 12 as a microphone and output to the control section 13. The control section 13 specifies the code defined in advance in association with the sounds. For example, it acquires information on the pitch of the acquired sounds (widely-known method can be employed). Then, the control section 13 acquires the numerical values defined in advance in association with this pitch information and thereby can acquire the setup information represented by this pitch. If plural frequencies are superimposed, the frequency components of the sounds output by the network storage 40 are identified by a Fourier transform and the code (numerical values) corresponding to the respective frequency components is identified.

In the above-described example, the user terminal 10 executes the processing of identifying the code corresponding to the setup information, i.e. the processing of reproducing the setup information from light or sounds output by the network storage 40. However, this processing may be executed in the server device 60. If the processing of reproducing the setup information from light or sounds output by the network storage 40 is executed in the user terminal 10, the setup information as the result of this reproduction is transmitted from the user terminal 10 to the server device 60. If this processing is executed in the server device 60, the user terminal 10 directly transmits, to the server device 60, the information acquired by the acquiring section 12, such as information representing a light blinking pattern (moving image information) or information on recorded sounds. Then, the setup information is reproduced from the light blinking pattern or pitch information in the server device 60.

This acquiring section 12 may be an input interface of a character string. In this case, the acquiring section 12 acquires the setup information as a character string input by the user's operation. In this case, the network storage 40 outputs the setup information as an image representing the character string.

The control section 13 is a program control device such as a CPU and controls the user terminal 10. This control section 13 acquires the setup information and instructs the communication section 11 to transmit the user request signal including the terminal identification information and the storage identification information for example. The user request signal is transmitted by using the URL information of the server device 60 (to the destination shown by this URL information) included in the setup information. The terminal identification information is e.g. an e-mail address transmitted and received by using the user terminal 10 via a line of a communications carrier.

This user request signal includes the setup information and further includes at least the terminal identification information to identify the user terminal 10.

Upon accepting an instruction from the server device 60 (e.g. password setting request signal to be described later), the control section 13 requests the user to input a password. Then, upon input of a password by the user, the control section 13 instructs the communication section 11 to transmit a password setting response signal including this input password.

The communication section 11 transmits the user request signal to the server device 60 via the first network (external network 50B or mobile communication network 80) in response to the instruction from the control section 13. Furthermore, the communication section 11 transmits the password setting response signal to the server device 60 via the first network (external network 50B or mobile communication network 80) in response to the instruction input from the control section 13.

In the following, the server device 60 according to the present embodiment will be described below. FIG. 5 is a configuration block diagram showing an example of the server device 60 according to the present embodiment.

As shown in FIG. 5, the server device 60 of the present embodiment includes a communication section 61, a state transition section 62, a pairing section 63, and a control section 64.

The communication section 61 is connected to the first network. The communication section 61 communicates with the network storage 40 via the first network and the second network (home network 50A). This communication section 61 also communicates with the user terminal 10.

In the present embodiment, this communication section 61 receives the storage request signal from the network storage 40. Furthermore, this communication section 61 receives the user request signal and the password setting response from the user terminal 10. In addition, this communication section 61 transmits the setup information to the network storage 40 in response to the storage request signal as described later.

The state transition section 62 transitions to the standby state to wait for the user request signal transmitted from the user terminal 10 in response to the storage request signal. It is preferable for the standby state to be canceled at the timing of the elapse of a predetermined period.

When the user request signal is received from the user terminal 10 in the standby state, the pairing section 63 performs associating (pairing) between this user terminal 10 and the network storage 40 identified by the storage identification information in the setup information included in the user request signal. Specifically, this pairing section 63 associates the terminal identification information and the storage identification information included in the user request signal with each other and stores them.

As already described, the user request signal includes the storage identification information to identify the network storage 40 and the terminal identification information to identify the user terminal 10. Therefore, the user request signal enables the pairing.

In the case of the setup information including individual URL information, information to uniquely identify the network storage 40 (storage identification information) is included in the URL indicating the web server of the server device 60. Thus, the pairing section 63 can identify the storage identification information.

The pairing section 63 rejects pairing when the user request signal is received in the state in which the standby state has been canceled.

When receiving the storage request signal, the control section 64 instructs the state transition section 62 to transition to the standby state. Furthermore, when accepting the user request signal, this control section 64 instructs the pairing section 63 to perform pairing.

When receiving the user request signal in the standby state, the control section 64 instructs the communication section 61 to transmit the password setting request to request setting of a password. Then, the control section 64 accepts the password setting response including the password. Then, when the terminal identification information of the user terminal 10 and the storage identification information to identify the network storage 40 are stored in association with each other, the control section 64 instructs the pairing section 63 to further associate this accepted password with these pieces of information and store the password.

That is, the control section 64 may instruct the pairing section 63 to perform pairing of the terminal identification information, the storage identification information, and the password in response to the password setting response.

In the present embodiment, upon receiving the storage request signal, the control section 64 instructs the communication section 61 to transmit the setup information. The communication section 61 transmits the setup information to the network storage 40 in response to the instruction from the control section 64.

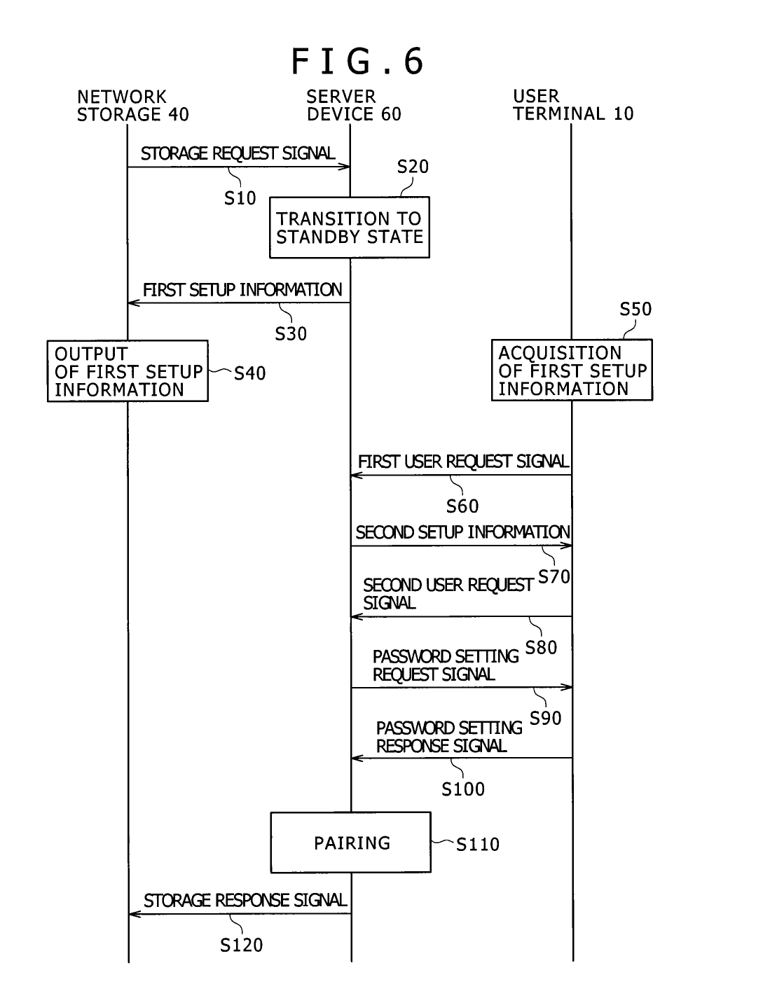

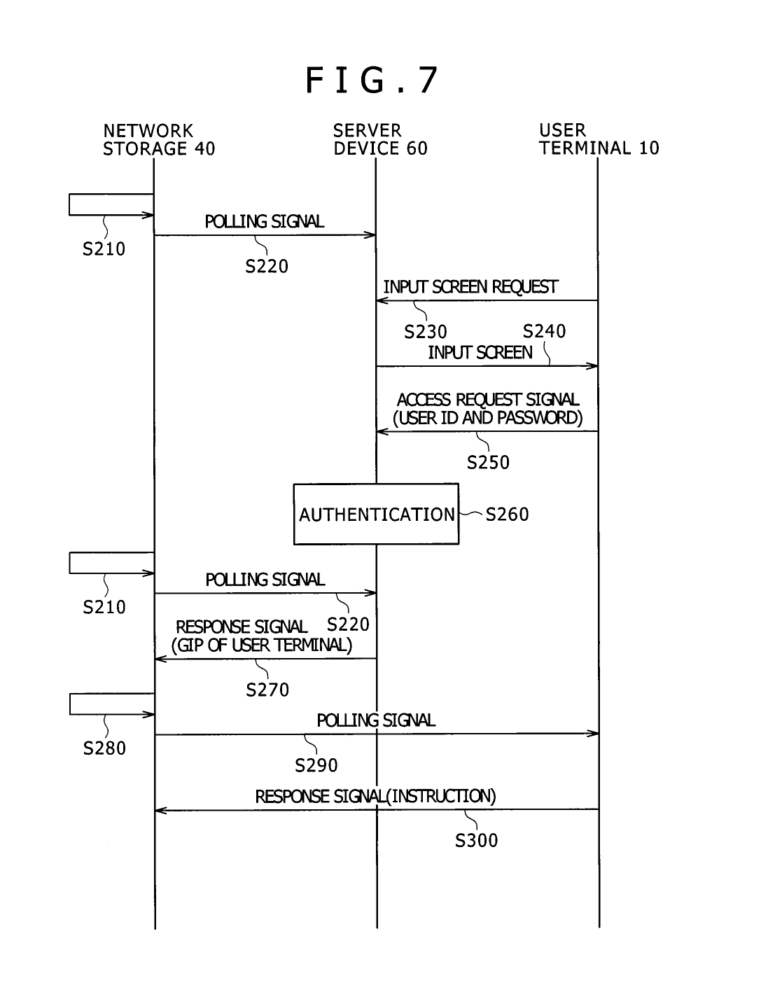

Next, the operation of the communication system according to the present embodiment will be described below. FIGS. 6 and 7 are sequence diagrams showing an operation example of the communication system 100 according to the present embodiment.

First, the procedure of pairing between the terminal identification information and the storage identification information will be described with reference to FIG. 6.

In this procedure, first setup information and second setup information are used as the setup information. The pairing between the terminal identification information and the storage identification information is performed by two-stage processing.

The first setup information is a set of general-purpose URL information as reference information of the web server of the server device 60 and the storage identification information and is transmitted from the server device 60 to the network storage 40. The second setup information is individual URL information that is reference information of the web server of the server device 60 and includes information to uniquely identify the network storage 40, and is transmitted from the server device 60 to the user terminal 10.

It is preferable for the second setup information (individual URL information) to be information that becomes invalid at the timing when the user request signal is received when the server device 60 is in the standby state. In other words, it is preferable for this second setup information (individual URL information) to be one-time URL information permitted to be used only once. In this individual URL information, e.g. the MAC address of the network storage 40 may be included (as a parameter).

As shown in FIG. 6, when predetermined operation defined in advance (e.g. pressing-down of a button) is performed, the network storage 40 transmits the storage request signal to the server device 60 via the second network (here, home network 50A) (step S10). In this storage request signal, the storage identification information to identify the network storage 40 is included.

The server device 60 receives this storage request signal. Then, the server device 60 transitions to the standby state to wait for the user request signal from the user terminal 10 (step S20). This standby state is canceled at the elapse of a certain period.

Furthermore, when the storage request signal is received, the server device 60 transmits the first setup information to the network storage 40 connected to the second network (home network 50A) (step S30).

The network storage 40 outputs the first setup information received from the server device 60. This first setup information is output after being coded by a predetermined method such as a method employing e.g. an image, a light blinking pattern, or the DTMF sound (step S40).

The user of the user terminal 10 operates the user terminal 10 to make the user terminal 10 acquire this first setup information output by the network storage 40 (step S50). In this procedure, the first setup information includes general-purpose URL information of the server device 60 and the storage identification information as described above.

The user terminal 10 transmits a first user request signal including the terminal identification information and the storage identification information to the server device 60 (step S60). This first user request signal is transmitted to the website referenced based on the general-purpose URL included in the first setup information (website provided by the server device 60) by using this general-purpose URL information. The following description is based on the premise that the terminal identification information is an e-mail address.

When receiving this first user request signal in the standby state, the server device 60 transmits the second setup information to the user terminal 10, which is the transmission source of this first user request signal. This second setup information is individual URL information that includes information to uniquely identify the network storage 40 and indicates a website of the server device 60 as described above (step S70).

If the first user request signal is received after the standby state is canceled, the server device 60 transmits information indicating rejection of transmission of the second setup information to the user terminal 10.

Upon receiving the individual URL information, the user terminal 10 transmits the second user request signal including the terminal identification information to the server device 60. This second user request signal is transmitted by using the second setup information. The storage identification information is included in the destination URL of this second user request signal (step S80). Specifically, this second user request signal is transmitted to the website indicated by the individual URL information included in the second setup information (storage identification information is included as a parameter in this individual URL information). Therefore, the server device 60 can acquire the storage identification information.

Upon receiving the second user request signal, the server device 60 transmits the password setting request signal to the user terminal 10 (step S90). In this example, the server device 60 can transmit the password setting request signal by an e-mail because the e-mail address of the user terminal 10 is acquired as the terminal identification information.

The user terminal 10 that has received the password setting request signal prompts the user to input a password. Then, upon input of the password to be set by the user, the user terminal 10 transmits the password setting response signal including this input password to the server device 60 (step S100). The password setting request signal may be a webpage that is referenced based on an individual URL on the server device 60 and includes a password entry field. With this webpage displayed on the user terminal 10, the user terminal 10 may prompt the user to input a password in this password entry field. In this case, the password input by the user is transmitted to the server device 60 by clicking a transmission (submit) button provided in this webpage. Alternatively, if the password setting request signal is transmitted by an e-mail from the server device 60, the user of the user terminal 10 may return an e-mail in which the password to be set is described. The password setting request signal and the password may be encrypted.

The server device 60 acquires the terminal identification information and the storage identification information from the second user request signal received from the user terminal 10, and separately receives the password from the user terminal 10. Then, this server device 60 associates the terminal identification information, the storage identification information, and the password with each other and stores them to perform associating (pairing) between the network storage 40 and the user terminal 10 (step S110).

The server device 60 may transmit a notification of rejection of the pairing to the user terminal 10 if receiving the second user request signal in the state in which the standby state has been canceled. Furthermore, the server device 60 may transmit a notification of rejection of the pairing to the user terminal 10 if receiving the password setting response signal in the state in which the standby state has been canceled.

Moreover, if the one-time URL is employed as the second setup information (individual URL information), the following configuration may be employed. Specifically, the server device 60 stores at least part (specifically, parameter part) of the individual URL information indicating the webpage accessed in at least a certain period in the past. Then, when access from the user terminal 10 to a webpage indicated by individual URL information is made, the server device 60 transmits a notification of rejection of the pairing to the user terminal 10 if it is the second time that the request for the webpage indicated by this individual URL information is issued.

The server device 60 transmits a storage response signal to the network storage 40 connected to the second network (home network 50A) (step S120).

Although the example in which the first setup information and the second setup information are used as the setup information is shown in FIG. 6, the present embodiment is not limited thereto. Specifically, utilization of the second setup information may be omitted and the pairing between the terminal identification information and the storage identification information may be performed by one-stage processing. In such a case, individual URL information including information to uniquely identify the network storage 40 is employed as the first setup information.

Next, an example of the procedure of access to the network storage 40 via the server device 60 by the user terminal 10 after pairing will be described below with reference to FIG. 7.

As shown in FIG. 7, every time the elapse of predetermined time is detected (step S210), the network storage 40 transmits a polling signal to the server device 60 via the router 20A (step S220). That is, this polling signal is repeatedly transmitted at every predetermined time. The polling signal includes the IP address of the server device 60 used in the connection to the wide area network 70 (i.e. WAN-side IP address of the server device 60) as the destination address and includes the IP address of the router 20A used in the connection to the wide area network 70 (i.e. WAN-side IP address of the router 20A) as the source address.

When accessing the network storage 40, the user of the user terminal 10 carries out operation to transmit the request for this access to the server device 60. The user terminal 10 that has received this operation transmits an input screen request signal to the server device 60 in order to request the server device 60 to send an input screen (step S230).

The server device 60 that has received the input screen request signal transmits an image of the predetermined input screen to the user terminal 10 (step S240). This input screen request signal may be e.g. a webpage referenced based on a predetermined URL and the input screen may be one described as a webpage. Furthermore, in this procedure, an interface for input of the storage identification information as the access target and input of a password is included in the input screen.

The user of the user terminal 10 inputs the storage identification information and the password through operation on this input screen (step S250). Then, when being instructed to transmit (submit) the storage identification information and the password by the user, the user terminal 10 transmits an access request signal including these storage identification information and password to the server device 60. The access request signal includes the IP address of the server device 60 used in the connection to the wide area network 70 (i.e. WAN-side IP address of the server device 60) as the destination address and includes the IP address of the user terminal 10 used in the connection to the wide area network 70 (i.e. WAN-side IP address of the user terminal 10) as the source address.

The server device 60 authenticates the storage identification information and the password received from the user terminal 10 (step S260). Specifically, with reference to information on the stored pairing, the server device 60 checks whether or not the terminal identification information to identify the user terminal 10 as the transmission source of the storage identification information and the password, the received storage identification information, and the received password are stored in association with each other.

The server device 60 stops the processing if the authentication fails, i.e. if the terminal identification information to identify the user terminal 10 as the transmission source of the storage identification information and the password, the received storage identification information, and the received password are not stored in association with each other. In this case, access from the user terminal 10 to the network storage 40 is not made.

On the other hand, the server device 60 stores the access request signal from the user terminal 10 if the authentication succeeds, i.e. if the terminal identification information to identify the user terminal 10 as the transmission source of the storage identification information and the password, the received storage identification information, and the received password are stored in association with each other.

Furthermore, every time the server device 60 receives the polling signal from the network storage 40, the server device 60 checks whether or not the access request signal including the storage identification information of the network storage 40 as the transmission source of this polling signal is stored. The server device 60 does not execute particular processing if the access request signal including the storage identification information of the network storage 40 as the transmission source of the polling signal is not stored.

If the access request signal including the storage identification information of the network storage 40 as the transmission source of the polling signal is stored, the server device 60 transmits, to the network storage 40, a response signal including the IP address (WAN-side IP address) of the user terminal 10 included in this stored access request signal by using the IP address on the side of the wide area network 70 (on the WAN side), of the router 20A on the second network, to which the network storage 40 as the transmission source of this polling signal is connected (step S270).

This response signal may be the access request signal itself received from the user terminal 10 and stored. The response signal includes the WAN-side IP address of the router 20A used in the connection to the wide area network 70 as the destination address and includes the WAN-side IP address of the server device 60 used in the connection to the wide area network 70 as the source address.

The router 20A translates the WAN-side IP address of the router 20A as the destination of the response signal transmitted by the server device 60 in response to the polling signal to the local IP address of the network storage 40 (NAT function) and sends out the response signal to the network storage 40.

Thereafter, when detecting the elapse of predetermined time (step S280), the network storage 40 transmits a polling signal to the (WAN-side) IP address of the user terminal 10, received by the response signal (step S290). This polling signal includes the WAN-side IP address of the user terminal 10 included in the response signal as the destination address and includes the WAN-side IP address of the router 20A used in the connection to the wide area network 70 as the source address.

In response to the polling signal received from the network storage 40, the user terminal 10 transmits, to the network storage 40, a response signal including an instruction to the network storage 40 via the router 20A (step S300). This instruction is to request data upload to the network storage 40 or data download. The response signal includes the WAN-side IP address of the router 20A used in the connection to the wide area network 70 as the destination address and includes the WAN-side IP address of the user terminal 10 used in the connection to the wide area network 70 as the source address.

In one mode of the present embodiment, the server device 60 transitions to the standby state in response to the storage request signal transmitted by the network storage 40 in response to predetermined operation carried out to the network storage 40 by the user. Furthermore, the server device 60 performs pairing between the user terminal 10 and the network storage 40 if receiving the user request signal from the user terminal 10 in this standby state.

At this time, as the storage identification information to identify the network storage 40, information output as e.g. light, sounds, or a character sting from the network storage 40 is automatically recognized by the user terminal 10. Thereby, the storage identification information is accepted. Thus, the user does not necessarily need to directly input this information. Furthermore, when the signal including this storage identification information and the terminal identification information of the user terminal 10 is sent out to the server device 60, the user terminal 10 does not necessarily need to belong to the same network as that to which the network storage 40 is connected. Specifically, the signal including this storage identification information and the terminal identification information of the user terminal 10 may be sent out to the server device 60 via the mobile communication network 80 by communication of a system such as the 3G or LTE.

Furthermore, the predetermined operation to the network storage 40 is necessary in pairing. Thus, pairing that is not intended by the user is not performed.

In addition, as the response signal to the polling from the network storage 40, the information that should be transmitted to the network storage 40 by the server device 60 or the user terminal 10 is transmitted. Thus, it is possible to directly transmit an instruction from the user terminal 10 to the network storage 40 by using the NAT function of the router 20A.

In a certain example of the present embodiment, the first setup information and the second setup information are used as the setup information. This second setup information is treated as a one-time URL so that pairing that is not intended by the user may be precluded.

In the present embodiment, the server device 60 transmits the setup information including information to uniquely identify the network storage 40 to the network storage 40 in response to the storage request signal, and the network storage 40 outputs the setup information. This information to uniquely identify the network storage 40 may be newly issued every time the server device 60 receives the storage request signal. That is, this information may be dynamic.

That is, writing or the like on which the setup information is printed does not need to be supplied with the network storage 40 in order to convey the setup information including the information to uniquely identify the network storage 40.

In the present embodiment, instead of outputting this setup information by itself, the network storage 40 may send out the setup information to another device (hereinafter, referred to as an output device 90) and make the output device 90 output it.

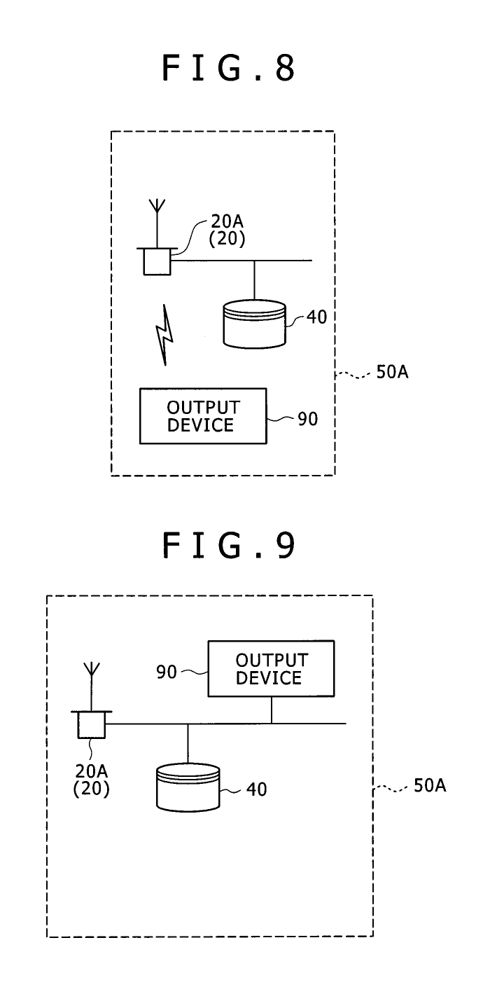

Specifically, as shown in FIGS. 8 and 9, the output device 90 is a device connected to the router 20A in a wired or wireless manner. The output device 90 is e.g. a device having a digital media player (DMP) function compliant with the digital living network alliance (DLNA). Examples of such a device include television, audio apparatus, and personal computer. In this case, the router 20A or the network storage 40 has a digital media server (DMS) function compliant with the DLNA. The network storage 40 sends out the setup information to the output device 90 and makes it be output by using this DMS function (or requesting the router 20A). The output device 90 outputs the setup signal sent out by the network storage 40 as e.g. an image, a light blinking pattern, or sounds. Specifically, the network storage 40 may generate a QR code representing the received setup information as a JPEG (Joint Photographic Experts Group) image and display it by the output device 90 such as a television serving as a DLNA client.

In this example, the setup information received by the network storage 40 is output from the output device 90. The user terminal 10 sends out the user request signal to the server device 60 by using the setup information output by this output device 90.

In the description made thus far, the network storage 40 itself has a communication function to communicate with the server device 60 and so forth. However, the present embodiment is not limited thereto.

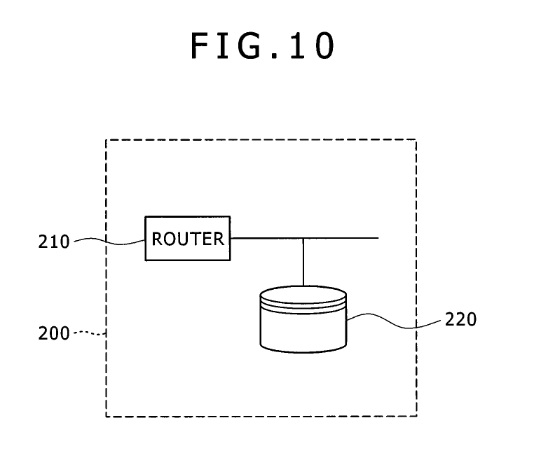

For example, as shown in FIG. 10, a network storage 200 may be so configured as to include a router 210 and an external storage 220 connected to this router 210.

The router 210 is connected to an in-house LAN in the user's home or the like. This router 210 may be a wireless router or may be a wired router. Specifically, of the functions of the already-described network storage 40, the functions as the communication section 41 and the control section 44 may be assumed by this router 210 and the other functions (functions of the operation section 42, the storing section 45, and the output section 43) may be realized by the external storage 220.

That is, the external storage 220 has a data storing function. This external storage 220 is connected to the router 210 via a bus interface (e.g. USB (universal serial bus) or IEEE (The Institute of Electrical and Electronics Engineers, Inc.) 1394).

Although the present embodiment is explained, it should not be understood that the description and drawings as part of this disclosure limit this invention. From this disclosure, various alternative embodiments, working examples, and operational techniques will be apparent for those skilled in the art.

In the present embodiment, the case in which the user terminal 10 has a wireless function is exemplified. However, the user terminal 10 does not necessarily need to have a wireless function and may be a terminal having a function to connect to a wired LAN.

A program causing a computer to carry out the respective steps shown in FIG. 6 or FIG. 7 may be provided. Specifically, a program to carry out the operation of the user terminal 10 and the network storage 40 and a program to carry out the operation of the server device 60 may be provided. Such a program may be so provided as to be recorded in a computer-readable recording medium. Such a recording medium may be a recording medium in which a program is fixedly recorded. For example, it may be a recording medium such as a CD-ROM (compact disk-read only memory) or a DVD-ROM (digital versatile disk-read only memory).

This network storage 40 may output the setup information as a signal to the user terminal 10. In such a case, the user terminal 10 is connected to the network storage 40 in a wireless or wired manner.

In a certain mode of this embodiment, the user terminal 10 performs data communication via a cell-phone network such as the 3G or LTE. Besides, it is also capable of data communication via a wireless LAN interface.

The network storage 40 is connected to e.g. a local area network (LAN) in the home of the user of the user terminal 10 or the place of work. Although the bridge of a wireless LAN is connected to the LAN to which this network storage 40 is connected, it is often difficult for the user of the user terminal 10 to connect the user terminal 10 to the LAN via the bridge and then set up the network storage 40 e.g. when this user is unaccustomed to the operation of the device. However, even such a user can utilize data communication via a wireless communication line set up in advance on the carrier side, i.e. via a cell-phone network, in many cases.

So, in a certain mode of this embodiment, devices operate in the following manner based on the premise that the user of the user terminal 10 can connect to the server device 60 existing on the Internet via a cell-phone network.

The network storage 40 is provided with a button. When the user presses down this button, the network storage 40 sends out a predetermined signal (storage request signal) to the address of the server device 60 defined in advance (URL defined as the destination of the storage request signal in advance). In this mode of the present embodiment, the storage request signal may have a form of request for a webpage by use of the HTTP (Hyper Text Transfer Protocol).

The server device 60 receives this storage request signal and issues the storage identification information to uniquely identify the network storage 40. This storage identification information may be e.g. the MAC address of the network storage 40. The server device 60 sends out the setup information including this issued storage identification information to the network storage 40. Furthermore, at this time, the server device 60 transitions to the standby state. The server device 60 in the standby state may time the elapsed time from the start of the standby state, and cancel the standby state to stop the processing if the user request signal to be described later is not received before predetermined time elapses.

The network storage 40 outputs the setup information received from the server device 60. This output can be carried out by various methods such as a character string by a display, a light blinking pattern, and sounds.

The user of the user terminal 10 inputs this setup information output by the network storage 40 to the user terminal 10 or makes the user terminal 10 recognize the setup information. In the case of making the user terminal 10 recognize it, computer-readable information is employed as a character string or a light blinking pattern. Also as sounds, sounds that can be recognized by a computer (e.g. DTMF) are used.

The user terminal 10 that has received the input of the setup information transmits a signal including the storage identification information and the terminal identification information of the user terminal 10 (user request signal) by using this setup information.

When the user request signal is received from the user terminal 10, the server device 60 compares the storage identification information included in this signal with the storage identification information issued when the server device 60 transitions to the standby state. When they correspond with each other, the server device 60 sends out a predetermined webpage to the user terminal 10, which is the transmission source of this user request signal.

In this webpage, e.g. an entry field of the password may be included. When the user of the user terminal 10 inputs the necessary information to this password entry field and instructs the user terminal 10 to transmit (submit) the information, this input information is accepted by the server device 60.

The server device 60 associates the storage identification information and the terminal identification information of the user terminal 10 received as the user request signal and the transmitted password and stores them as the pairing information.

Thereafter, the server device 60 may transmit predetermined information to the network storage 40 as a response to the storage request signal.

From then on, when the user of the user terminal 10 accesses the predetermined URL of the server device 60 (URL of the webpage defined as the site for access to the network storage 40 in advance), the server device 60 transmits a webpage prompting input of the terminal identification information of this user terminal 10 and the password.

The user of the user terminal 10 inputs the terminal identification information of the user terminal 10 (phone number, e-mail address, etc. of the user terminal 10) and the password on this webpage and transmits (submits) them.

The server device 60 searches for the pairing information including this transmitted terminal identification information. When the pairing information including the transmitted terminal identification information is found, the server device 60 compares the password included in this found pairing information with the transmitted password. If the password included in the found pairing information does not correspond with the transmitted password, the server device 60 transmits a webpage indicating the occurrence of an error to the user terminal 10.

If the password included in the pairing information found as a result of the search corresponds with the transmitted password, the server device 60 associates the terminal identification information of this user terminal 10 with the IP address and stores them.

Meanwhile, the network storage 40 accesses the server device 60 at every predetermined timing (e.g. periodically) and inquires whether or not a request to the network storage 40 is issued from the user terminal 10. This inquiry can also be performed by utilizing the HTTP.

The server device 60 extracts the storage identification information included in this inquiry and searches for the pairing information including this extracted storage identification information (referred to as storage-of-interest identification information). If the pairing information including this storage-of-interest identification information is absent, the server device 60 discards this inquiry.

If the pairing information including the above-described storage-of-interest identification information is found by the search, the server device 60 checks whether or not the IP address stored in association with the terminal identification information included in the pairing information found by this search (referred to as terminal-of-interest identification information) is present. If such an IP address is absent, the server device 60 ends the processing (makes no response).

If the IP address stored in association with the terminal-of-interest identification information is found by the search, the server device 60 transmits the IP address found by this search to the network storage 40 identified by the storage-of-interest identification information.

From then on, the network storage 40 inquires of this IP address (IP address of the user terminal 10) whether or not an operation request is present at every predetermined timing. The user terminal 10 transmits a request to the network storage 40 as a response to this inquiry in accordance with user's instruction. The network storage 40 executes processing appropriate for this request and communicates with the user terminal 10 according to need.

In one example of the present embodiment, the setup information issued by the server device 60 does not necessarily need to have a fixed length. Specifically, it may be variable-length information included between predetermined start bit and stop bit. In this case, the server device 60 changes the length of the setup information depending on e.g. the present load of the self or the average load of a predetermined past period. Specifically, when the load is small, the number of network storages for which pairing is required is small and the number of network storages that should be uniquely identified is also small. Therefore, the bit length of the setup information may be set short. If the load is large, the bit length of the setup information is set long.

Moreover, as this processing depending on e.g. the present load of the self or the average load of a predetermined past period, the period from transition to the standby state to cancel of the standby state may be changed based on the magnitude of this load. Specifically, when the load is large, the period until the cancel of the standby state is set longer than a period defined in advance. When the load is small, the period until the cancel of the standby state is set to the period defined in advance.

It should be understood by those skilled in the art that various modifications, combinations, sub-combinations and alternations may occur depending on design requirements and other factors insofar as they are within the scope of the appended claims or the equivalent thereof.

What is claimed is:

1. A communication system comprising:
a server connected to a first network;
a network storage connected to a second network different from the first network and configured to communicate with the server; and
a user terminal, wherein
the network storage transmits a storage request signal to the server in response to predetermined operation received at the network storage,
the server transitions to a standby state in response to the storage request signal and issues setup information to the network storage, the setup information including storage identification information identifying the network storage,
the network storage receives the setup information from the server and outputs the setup information,
the user terminal transmits, to the server, a user request signal including the storage identification information identifying the network storage and terminal identification information identifying the user terminal based on the setup information output by the network storage, and
the server associates the terminal identification information and the storage identification information when the user request signals is received from the user terminal and when the server is in the standby state.

2. The communication system of claim 1, wherein
the setup information indicates a Uniform Resource Locator (URL) corresponding to the server and the storage identification information.

3. The communication system of claim 1, wherein
the server transmits second setup information to the user terminal upon receiving the user request signal, the second setup information indicating a Uniform Resource Locator (URL) corresponding to the server and information uniquely identifying the network storage.

4. The communication system of claim 3, wherein
the server controls invalidates the URL included in the second setup information after receiving the user request signal from the user terminal.

5. The communication system of claim 3, wherein
the user terminal transmits a second user request signal to the server based on the URL included in the second setup information, the second user request signal including the terminal identification information.

6. The communication system of claim 1, wherein
the server transmits a password setting request signal to the user terminal in response to receiving the user request signal from the user terminal.

7. The communication system of claim 6, wherein
the user terminal displays an interface configured to receive a password input by a user in response to receiving the password setting request signal.

8. The communication system of claim 7, wherein
the user terminal transmits a password setting response signal to the server indicating the password input at the interface upon receiving a password input at the interface.

9. The communication system of claim 8, wherein
the server associates the terminal identification information, the storage identification information and the password upon receiving the password setting response signal from the user terminal.

10. A network storage that communicates with a server connected to a first network and is connected to a second network different from the first network, the network storage comprising:
a communication interface configured to
transmit, to the server, a storage request signal controlling the server to transition to a standby state to wait for a user request signal transmitted from a user terminal configured to communicate with the server in response to predetermined operation;
receive setup information issued by the server in response to the storage request signal, the setup information including storage identification information identifying the network storage; and
an output section that outputs the setup information received from the server.

11. The network storage according to claim 10, wherein
the output section includes a display and outputs the setup information as an image.

12. The network storage according to claim 10, wherein
the output section includes a light source configured to output the setup information as a light blinking pattern.

13. The network storage according to claim 10, wherein
the output section includes a speaker configured to output the setup information as a sound.

14. The network storage according to claim 10, wherein
the output section includes a communication interface configured to output the setup information to another device connected to the network storage.

15. A server that is connected to a first network and communicates with a user terminal and a network storage connected to a second network different from the first network, the server comprising:
a communication interface configured to receive a storage request signal transmitted by the network storage in response to a predetermined operation at the network storage; and
circuitry configured to control the server to transition to a standby state to wait for a user request signal transmitted from the user terminal in response to the storage request signal, wherein
the communication interface is configured to transmit setup information including storage identification information identifying the network storage to the network storage in response to the storage request signal,
the circuitry is configured to associate terminal identification information identifying the user terminal with the storage identification information and control a memory to store the terminal identification information and the storage identification information when the server receives the user request signal and when the server is in the standby state, and
the user request signal is transmitted based on the setup information including the storage identification information and includes the storage identification information and the terminal identification information.

16. A method performed by a network storage that communicates with a server connected to a first network and is connected to a second network different from the first network, the method comprising:
transmitting, to the server by a communication interface of the network storage, a storage request signal controlling the server to transition to a standby state to wait for a user request signal transmitted from a user terminal configured to communicate with the server in response to predetermined operation;
receiving, by the communication interface, setup information issued by the server in response to the storage request signal, the setup information including storage identification information identifying the network storage; and
outputting the setup information received from the server.

17. A method performed by a server that is connected to a first network and communicates with a user terminal and a network storage connected to a second network different from the first network, the method comprising:
receiving a storage request signal transmitted by the network storage in response to predetermined operation at the network storage;
controlling, by circuitry of the server, the server to transition to a standby state to wait for a user request signal transmitted from the user terminal in response to the storage request signal;
transmitting setup information including storage identification information identifying the network storage to the network storage in response to the storage request signal; and
associating, by the circuitry, terminal identification information identifying the user terminal with the storage identification information and storing the terminal identification information and the storage identification information when the server receives the user request signal and when the server is in the standby state, wherein
the user request signal is transmitted based on the setup information including the storage identification information and includes the storage identification information and the terminal identification information.
